(19) United States
(12) Patent Application Publication
(10) Pub. No.: US 2015/0355580 A1
(43) Pub. Date: Dec. 10, 2015

(54) LEAK BARRIER FOR DEVELOPER CARTRIDGE

(71) Applicant: Clover Technologies Group, LLC, Ottawa, IL (US)

(72) Inventor: Rui CARDOSO, Porto (PT)

(21) Appl. No.: 14/731,500

(22) Filed: Jun. 5, 2015

Related U.S. Application Data
(60) Provisional application No. 62/008,138, filed on Jun. 5, 2014.

(51) Int. Cl. G03G 15/08; G03G 21/18

(52) U.S. Cl. CPC G03G 15/0898; G03G 21/181; G03G 2215/00987

(57) ABSTRACT

A developer barrier sheet is positioned between a developer roller and a developer opening in a developer cartridge to reduce leaking of developer from the developer cartridge during shipping. The barrier sheet may be positioned into a developer cradle area before the developer roller is installed so that, upon installation of the developer roller, the barrier sheet is captured between the developer roller and various cartridge seals that surround the developer opening.

### CROSS REFERENCE TO RELATED APPLICATION

This application claims the benefit of and priority to U.S. Provisional Patent Application No. 62/008,138, filed Jun. 5, 2014, the entire contents of which are hereby incorporated by reference herein.

### BACKGROUND

Developer cartridges for laser printers and copiers are replaceable components that supply developer or toner to the optical photoconductive drum (“OPC”) of a laser printer or copier. Developer cartridges generally include a housing for storing developer, a drive mechanism for receiving driving force from the printer or copier, and a series of rollers for transferring developer from the housing to the OPC. Developer cartridges are transported from manufacturing facilities throughout the world. One issue of concern for manufacturers of developer cartridges is the leaking of developer from the cartridge during transport. A variety of seals, blades, covers, and the like have been used in attempts to reduce the amount of developer that leaks from the cartridge during transport, but certain cartridge designs have remained prone to leaking during transport.

### SUMMARY

In some aspects, a developer cartridge includes a housing defining an elongated developer opening having a top edge and a bottom edge, a developer roller cradle adjacent the developer opening, and a pair of developer mounts on opposite ends of the developer opening. A developer roller is positioned in the developer roller cradle and rotatably supported by the developer mounts. A developer barrier is positioned between the developer roller and the developer roller cradle and covers the developer opening. The developer barrier contacts and wraps partially around the developer roller and includes a depending portion extending generally tangentially away from the developer roller cradle to facilitate removal of the developer barrier from between the developer roller and the developer roller cradle.

A first seal may extend along a top edge of the developer opening and a second seal may extend along the bottom edge of the developer opening, and the developer barrier may directly engage the first and second seals. The first seal may include a doctor blade for regulating a thickness of a layer of developer on the developer roller during operation of the developer cartridge. A third seal may extend along one side of the developer opening and a fourth seal may extend along an opposite side of the developer opening. The developer barrier may directly engage the third and fourth seals. The housing may include a first concave semi-cylindrical surface on a first end of the developer opening, and a second concave semi-cylindrical surface on a second end of the developer opening opposite the first end. The developer barrier may directly engage the first concave semi-cylindrical surface and the second concave semi-cylindrical surface. The developer barrier may comprise a sheet of paper. The developer roller cradle may be at least partially defined by a first seal extending along the top edge of the developer opening and a second seal extending along the bottom edge of the developer opening. The developer barrier may directly contact the first and second seals. The developer barrier may be positioned directly between the developer roller and each of the first and second seals, and portions of the first and second seals that do not directly contact the developer roller with the developer barrier installed may directly contact the developer roller upon removal of the developer barrier. The first seal may comprise a doctor blade and the second seal may comprise a strip of polyester film (e.g., MYLAR, available from DuPont Teijin Films).

In other aspects, a method of assembling a developer cartridge is provided. The developer cartridge includes a housing defining a developer opening and a developer roller cradle surrounding the opening. The method includes positioning a developer barrier sheet into the developer roller cradle to overlie the developer opening, and rotatably mounting a developer roller within the developer roller cradle to secure the developer barrier sheet between the developer roller and thOKe developer roller cradle.

Rotatably mounting the developer roller within the developer roller cradle may include directly contacting the developer barrier sheet to both the developer roller and the developer roller cradle. Positioning the developer barrier sheet within the developer roller cradle may include positioning the developer barrier sheet against a first seal extending along a top edge of the developer opening and against a second seal extending along a bottom edge of the developer opening. Positioning the developer barrier sheet within the developer roller cradle may also or alternatively include positioning a depending portion of the developer barrier sheet to extend away from the developer roller cradle, and upon rotatably mounting the developer roller within the developer roller cradle, the depending portion may extend generally tangentially away from the developer roller cradle.

In still other aspects, a method of remanufacturing a previously used developer cartridge is provided. The previously used developer cartridge includes a housing defining a developer opening and a developer roller cradle surrounding the developer opening. The developer cartridge further includes a developer roller rotatably positioned in the developer roller cradle. The method includes removing the developer roller from the developer roller cradle, cleaning at least a portion of housing, refilling the housing with developer, positioning a developer barrier sheet into the developer roller cradle to overlie the developer opening, and reinstalling the developer roller within the developer roller cradle to secure the developer barrier sheet between the developer roller and the developer roller cradle.

Rotatably mounting the developer roller within the developer roller cradle may include directly contacting the developer barrier sheet to both the developer roller and the developer roller cradle. Positioning the developer barrier sheet within the developer roller cradle may include positioning the developer barrier sheet against a first seal extending along a top edge of the developer opening and against a second seal extending along a bottom edge of the developer opening. Positioning the developer barrier sheet within the developer roller cradle may include positioning a depending portion of the developer barrier sheet to extend away from the developer roller cradle, and upon reinstalling the developer roller within the developer roller cradle, the depending portion may extend generally tangentially away from the developer roller cradle. The housing may include a plurality of seals surrounding the developer opening, and the method may further include at least one of replacing and refurbishing at least one of the plurality of seals.

### BRIEF DESCRIPTION OF THE DRAWINGS

FIG. 1 is a perspective view of a developer cartridge with a developer roller removed.

FIG. 2 is a perspective view of the developer cartridge of FIG. 1 with a developer barrier being positioned over a developer opening.

FIG. 3 is a perspective view of the developer cartridge of FIG. 1 with the developer roller being positioned in the developer opening while the developer barrier is in place.

FIG. 4 is a side perspective view of the developer cartridge of FIG. 1 with a shipping protector being installed over the developer roller.

FIG. 5 is a perspective view of the developer cartridge of FIG. 1 with the shipping protector in place and a securing member securing the developer barrier to the shipping protector.

FIG. 6 is a perspective view of the developer cartridge of FIG. 1 showing a user removing the developer barrier.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Also, it is to be understood that the phraseology and terminology used herein is for the purpose of description and should not be regarded as limiting.

### DETAILED DESCRIPTION

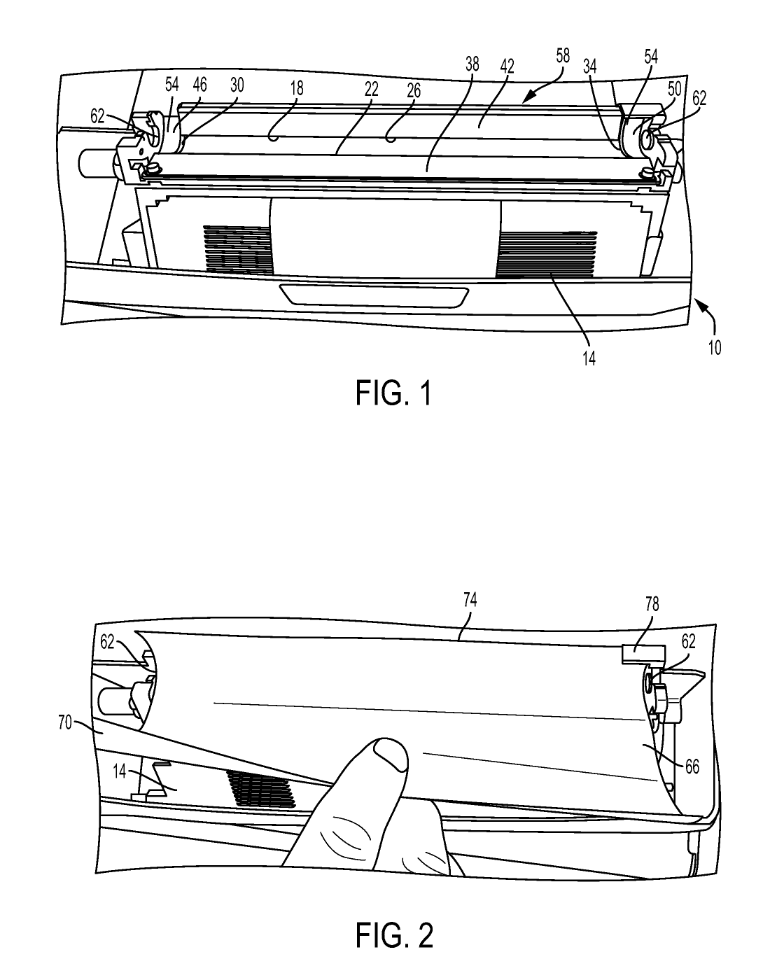

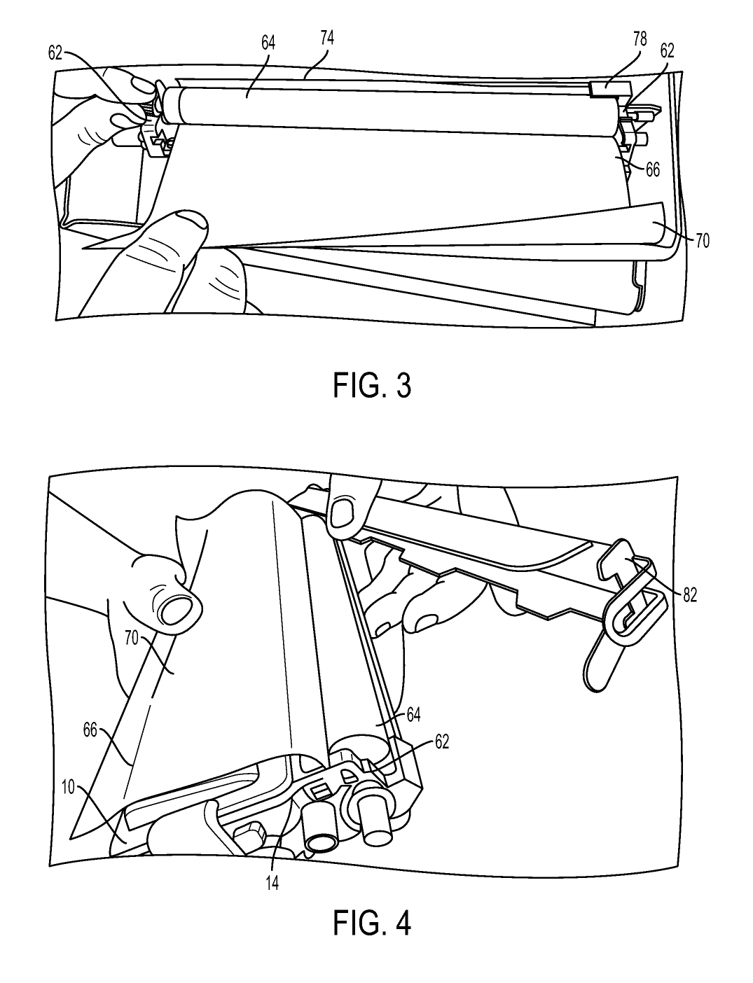

FIG. 1 illustrates a partially assembled developer cartridge 10. The cartridge 10 includes a housing 14 defining a developer opening 18. The developer opening 18 is generally rectangular and includes a top edge 22, a bottom edge 26, and two side edges 30, 34. A first seal 38 extends along the top edge 22, and a second seal 42 extends along the bottom edge. Third and fourth seals 46, 50, which may be in the form of side seals, extend along respective side edges 30, 34. The first seal 38, second seal 42, third seal 46, and fourth seals 50 generally may be comprised of foam, felt, or other suitable sealing materials. In some embodiments, including the illustrated embodiment, the first seal 38 may be or include a doctor blade, and the second seal 42 may be or include a polyester film strip. Each of the third and fourth seals 46, 50 defines a concaved, substantially semi-cylindrical surface 54. The first seal 38, the second seal 42, and the semi-cylindrical surfaces 54 cooperate to define a developer roller cradle 58 that generally surrounds and is adjacent to the developer opening 18. In some embodiments, the top edge 22, bottom edge 26 and two side edges 30, 34 of the developer opening 18 may be defined by the first seal 38, the second seal 42, and the semi-cylindrical surfaces 54, respectively. The housing 14 also defines a pair of opposed developer roller mounts 62 configured to support a developer roller 64 (FIGS. 3-4) for rotation about an axis. The mounts 62 may directly or indirectly support the developer roller 64 alone or in combination with other components of the developer cartridge

FIG. 2 illustrates a developer barrier sheet 66 being positioned to cover the developer opening 18. The developer barrier sheet 66 of the illustrated embodiment is a generally rectangular sheet having a width that substantially corresponds to a distance between the developer roller mounts 62. In this regard, the developer roller barrier sheet 66 is sized to extend width-wise between the two semi-cylindrical surfaces 54 and to at least partially cover the two semi-cylindrical surfaces 54. In the cross-wise direction, the developer roller barrier sheet 66 is sized to extend along and substantially cover the developer opening 18 and at least portions of the first seal 38 and the second seal 42. The barrier sheet 66 is further sized to include a depending portion 70 that extends in a generally tangential direction away from the developer roller cradle 58 and facilitates removal of the barrier sheet 66 from the cartridge 10, as discussed below. In some embodiments, including the illustrated embodiment, the housing 14 may include an overhanging portion 78 positioned adjacent to the developer roller cradle 58 and a leading edge 74 of the developer barrier sheet 66 may be abutted against the overhanging portion 78 to properly locate the developer barrier sheet 66 with respect to the developer opening 18. The specific size of the developer barrier sheet 66 depends upon the size of the developer cartridge 10 in which it is used. In general, the portion of the developer barrier sheet 66 that extends between the second seal 42, the first seal 38, and the surfaces 54 will be generally rectangular. The depending portion 70 of the developer barrier sheet 66 may be rectangular, as shown, or may be substantially triangular or some other shape that may allow for a reduction in material use. The barrier sheet 66 may be or include a sheet of paper, polymer film, woven material, other suitable web-like materials, and combinations thereof.

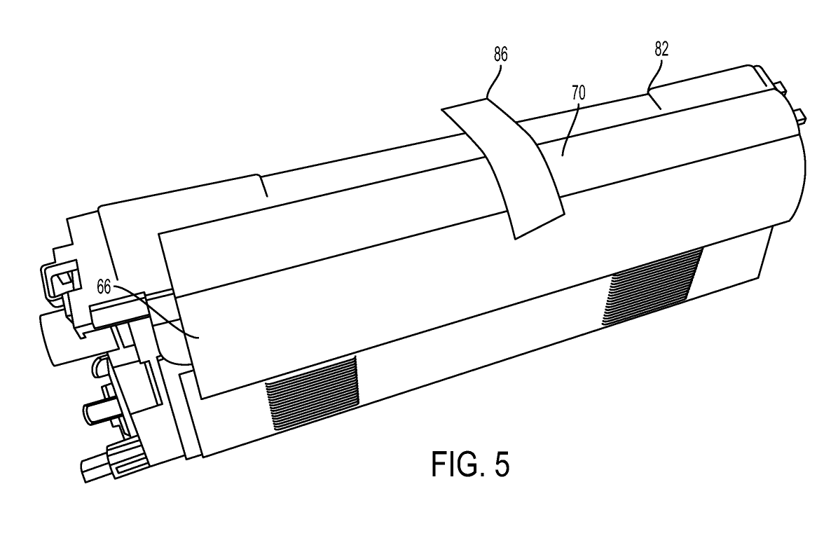

With the developer barrier sheet 66 positioned in the developer roller cradle 58, the developer roller 64 may be mounted to the developer roller mounts 62, as shown in FIG. 3. Although specifics can vary depending on the construction of a specific developer cartridge 10, installation of the developer roller 64 typically involves positioning one end of the developer roller 64, which may include a bearing, bushing, or similar structure, into one of the developer roller mounts 62, and then positioning the other end of the developer roller 64, which may also include a bearing, bushing, or similar structure, into the other of the developer roller mounts 62. As the developer roller 64 is installed, the developer barrier sheet 66 is captured between the developer roller 64 and the first seal 38, second seal 42, and semi-cylindrical surfaces 54. When the developer roller 64 is fully installed, the barrier sheet 66 directly engages the first seal 38, second seal 42, and semi-cylindrical surfaces 54, is wrapped around a portion of the circumference of the developer roller 64, and overlies the developer opening 18. In this regard the barrier sheet 66 is positioned and held snugly between the developer roller 64 and the first seal 38, second seal 42, and semi-cylindrical surfaces 54. The presence of the barrier sheet 66 reduces leakage of developer from the cartridge 10 during transportation. As shown in FIG. 4, a shipping protector 82 may be installed to cover and protect the exposed surfaces of the developer roller 64 during transport. As shown in FIG. 5, the depending portion 70 of the developer barrier sheet 66 may then be secured to the shipping protector 82, for example using a piece of tape 86.

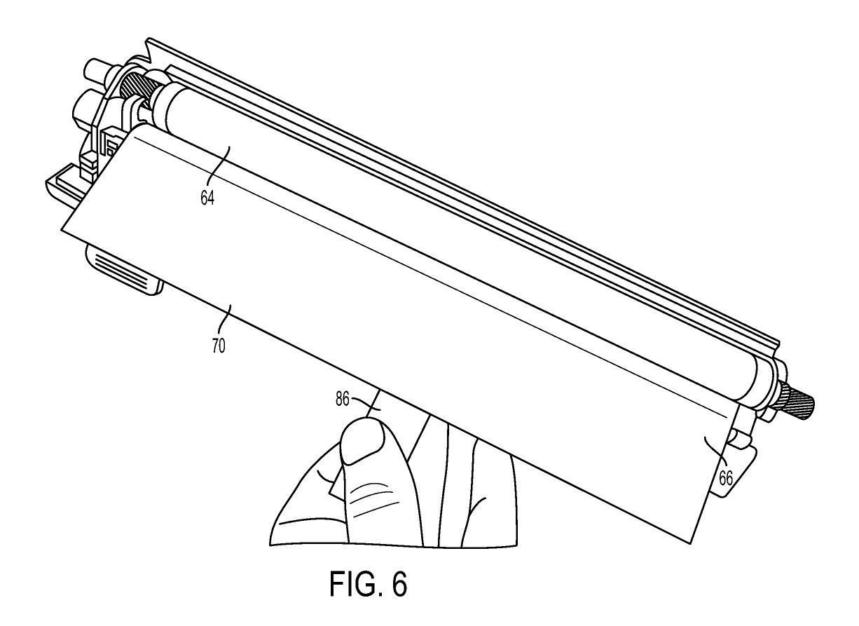

Referring to FIG. 6, when a user receives the cartridge 10, the user may use the piece of tape 86, if present, or the depending portion 70 to withdraw the developer barrier sheet 66 from between the developer roller 64 and the developer opening 18. When the developer barrier sheet 66 is removed, the developer roller 64 is brought into direct contact with the first seal 38, the second seal 42, and the semi-cylindrical side surfaces 54, and the developer opening 18 becomes unobstructed such that developer may move through the developer opening 18 and onto the developer roller 64 for printing operations. In this way, portions of the first seal 38, second seal 42 and semi-cylindrical side surfaces 54 that did not directly contact the developer roller with the barrier sheet 66 installed are brought into direct contact with the developer roller when the barrier sheet 66 is removed.

While the developer barrier sheet 66 and method described above can be used to improve the sealing characteristics of many developer cartridges, the developer barrier sheet 66 is particularly well suited for use in remanufactured developer cartridges in which one or more of the doctor blade 38, polyester film strip 42, and side seals 46, 50 may be somewhat worn from an initial cartridge life-cycle. In such cases, one or more of the first seal or doctor blade 38, second seal or polyester film strip 42, and third and fourth or side seals 46, 50 may be adequate for preventing leakage of developer during operation of the cartridge, but may be inadequate for preventing leakage of developer during transportation of the cartridge. Accordingly, in some aspects, a method of remanufacturing a developer cartridge may include removing the developer roller 64 from the developer roller mounts 62, cleaning the cartridge 10, replacing and/or refurbishing one or more of the first 38, second 42, third 46, or fourth seals 50 (for example the doctor blade 38, polyester film strip 42, and side seals 46, 50), refilling the housing 14 with toner, positioning the developer barrier sheet 66 in the developer roller cradle 58 to overlie the developer opening 18, and reinstalling the developer roller 64, which may be or include a new, replacement developer roller 64, into the developer roller mounts 62, thereby capturing the developer barrier sheet 66 between the developer roller 64 and the first, second, third, and fourth seals 38, 42, 46, and 50.

While specific embodiments have been illustrated and described, numerous modifications come to mind without significantly departing from the spirit of the disclosure, and the scope of protection is to be commensurate with the scope of the accompanying claims.

What is claimed is:

1. A developer cartridge comprising:
a housing defining an elongated developer opening having a top edge and a bottom edge, a developer roller cradle adjacent the developer opening, and a pair of developer mounts on opposite ends of the developer opening;
a developer roller positioned in the developer roller cradle and rotatably supported by the developer mounts; and
a developer barrier positioned between the developer roller and the developer roller cradle and covering the developer opening, the developer barrier contacting and wrapping partially around the developer roller and including a depending portion extending generally tangentially away from the developer roller cradle to facilitate removal of the developer barrier from between the developer roller and the developer roller cradle.

2. The developer cartridge of claim 1, further comprising a first seal extending along a top edge of the developer opening and a second seal extending along the bottom edge of the developer opening, and wherein the developer barrier directly engages the first and second seals.

3. The developer cartridge of claim 2, wherein the first seal includes a doctor blade for regulating a thickness of a layer of developer on the developer roller during operation of the developer cartridge.

4. The developer cartridge of claim 2, further comprising a third seal extending along one side of the developer opening and a fourth seal extending along an opposite side of the developer opening, and wherein the developer barrier directly engages the third and fourth seals.

5. The developer cartridge of claim 1, wherein the housing includes a first concave semi-cylindrical surface on a first end of the developer opening, and a second concave semi-cylindrical surface on a second end of the developer opening opposite the first end, and wherein the developer barrier directly engages the first concave semi-cylindrical surface and the second concave semi-cylindrical surface.

6. The developer cartridge of claim 1, wherein the developer barrier comprises a sheet of paper.

7. The developer cartridge of claim 1, wherein the developer roller cradle is at least partially defined by a first seal extending along the top edge of the developer opening and a second seal extending along the bottom edge of the developer opening, and wherein the developer barrier directly contacts the first and second seals.

8. The developer cartridge of claim 7, wherein the developer barrier is positioned directly between the developer roller and each of the first and second seals, and wherein portions of the first and second seals that do not directly contact the developer roller with the developer barrier installed directly contact the developer roller upon removal of the developer barrier.

9. The developer cartridge of claim 8, wherein the first seal comprises a doctor blade and the second seal comprises a polyester film strip.

10. A method of assembling a developer cartridge, the developer cartridge including a housing defining a developer opening and a developer roller cradle surrounding the opening, the method comprising:
positioning a developer barrier sheet into the developer roller cradle to overlie the developer opening; and
rotatably mounting a developer roller within the developer roller cradle to secure the developer barrier sheet between the developer roller and the developer roller cradle.

11. The method of claim 10, wherein rotatably mounting the developer roller within the developer roller cradle includes directly contacting the developer barrier sheet to both the developer roller and the developer roller cradle.

12. The method of claim 10, wherein positioning the developer barrier sheet within the developer roller cradle includes positioning the developer barrier sheet against a first seal extending along a top edge of the developer opening and against a second seal extending along a bottom edge of the developer opening.

13. The method of claim 10, wherein positioning the developer barrier sheet within the developer roller cradle includes positioning a depending portion of the developer barrier sheet to extend away from the developer roller cradle, and wherein upon rotatably mounting the developer roller within the developer roller cradle, the depending portion extends generally tangentially away from the developer roller cradle.

14. A method of remanufacturing a previously used developer cartridge, the developer cartridge including a housing defining a developer opening and a developer roller cradle surrounding the developer opening, the developer cartridge further including a developer roller rotatably positioned in the developer roller cradle, the method comprising:
removing the developer roller from the developer roller cradle;
cleaning at least a portion of the housing;
refilling the housing with developer;
positioning a developer barrier sheet into the developer roller cradle to overlie the developer opening; and
reinstalling the developer roller within the developer roller cradle to secure the developer barrier sheet between the developer roller and the developer roller cradle.

15. The method of claim 14, wherein rotatably mounting the developer roller within the developer roller cradle includes directly contacting the developer barrier sheet to both the developer roller and the developer roller cradle.

16. The method of claim 14, wherein positioning the developer barrier sheet within the developer roller cradle includes positioning the developer barrier sheet against a first seal extending along a top edge of the developer opening and against a second seal extending along a bottom edge of the developer opening.

17. The method of claim 14, wherein positioning the developer barrier sheet within the developer roller cradle includes positioning a depending portion of the developer barrier sheet to extend away from the developer roller cradle, and wherein upon reinstalling the developer roller within the developer roller cradle, the depending portion extends generally tangentially away from the developer roller cradle.

18. The method of claim 14, wherein the housing includes a plurality of seals surrounding the developer opening, the method further comprising at least one of replacing and refurbishing at least one of the plurality of seals.
